(19) United States
(12) Patent Application Publication
(10) Pub. No.: US 2005/0283383 A1
(43) Pub. Date: Dec. 22, 2005

(54) Method of developing patient referrals using the internet

(76) Inventor: Gary Zammit, Norwalk, CT (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/146,834

(22) Filed: Jun. 6, 2005

Related U.S. Application Data
(60) Provisional application No. 60/577,229, filed on Jun. 4, 2004.

(51) Int. Cl. G06Q 50/00

(52) U.S. Cl. 705/2

(57) ABSTRACT

A Web-based software application that implements a method for referring Internet users to healthcare providers. Internet users are able to access healthcare information on a Website. Internet users may be attracted to the Website by various forms of advertisements, including print, television, radio, direct mail, Internet, or other forms of advertisement. The healthcare information accessible to Internet users at the Website may include information regarding medical or psychiatric disorders, including overviews of disorders, their incidence and prevalence, and their symptoms, pathophysiology, consequences, and treatments. General information regarding the diagnosis of conditions may be presented. Internet users are prompted to provide identifying information, such as, for example, information regarding diagnostic criteria or geographical information, which is used to determine matching healthcare providers, and information regarding the matching healthcare providers is provided to users.

### CROSS-REFERENCE TO RELATED U.S. APPLICATIONS

This application claims the benefit of co-pending Provisional Application Ser. No. 60/577,229, filed Jun. 4, 2004.

### BACKGROUND

In recent years there has been a significant rise in the number of Internet Websites dedicated to healthcare information. According to the Journal of Medical Internet Research, there are over 100,000 health-related Web sites on the Internet today. These sites are visited by approximately 86% of American adults who have access to the Internet. The use of the Internet to obtain healthcare information is expected to grow as more people gain Internet access and as more rely on Internet sources for reliable information. It is believed that Internet users are more likely to initiate a search for healthcare information by accessing the Internet than by speaking with their primary care physicians.

In addition to providing healthcare information, the Internet offers an opportunity to link Internet users with healthcare providers. Websites may offer contact information to Internet users, such as names, telephone numbers, and e-mail addresses, enabling them to reach healthcare providers. However, this information currently is presented in ways similar to listings found in most telephone books, albeit with opportunities to access e-mail functions.

### DESCRIPTION OF THE PREFERRED EMBODIMENTS

A Web-based software application is provided that implements a method for introducing (referring) Internet users to healthcare providers. Internet users are able to access healthcare information on a Website. Internet users may be attracted to the Website by various forms of advertisements, including print, television, radio, direct mail, Internet, or other forms of advertisement. In one embodiment of this method, users are able to access information about sleep and sleep disorders.

The Website may include information regarding medical or psychiatric disorders, including overviews of disorders, their incidence and prevalence, and their symptoms, pathophysiology, consequences, and treatments. General information regarding the differential diagnosis of conditions may be presented.

In one embodiment of the method, Internet users may complete a self-rating at the Website, enabling them to determine if they might meet diagnostic criteria for a medical or psychiatric condition. Results of self-ratings can be printed or can be sent to others electronically. For example, the results can be printed and delivered to one's own doctor, or e-mailed to one's own doctor.

In one embodiment of this method, Internet users may be able to search for a healthcare provider via the Website. General advice regarding the selection of a healthcare provider, qualifications to look for in a healthcare provider, the type of experience one might encounter when contacting a healthcare provider, and related information may be presented via the Website. The Internet user also may scan a list of providers (as in a directory format), may enter an e-mail address, zip code, and other identifying information in order to search for providers in his or her geographic area, or may use an on-line module to request an appointment with a local provider.

When Internet users submit their e-mail addresses, zip codes, or other identifying information, or if a patient makes an appointment request, the user information is sorted. Key aspects of the identifying information are used to automatically match the Internet user with a healthcare provider or group of healthcare providers. For example, the user's zip code may be used to identify healthcare providers within the user's geographic area.

Once the software application has identified healthcare providers, an automated e-mail may be sent to the provider, or the user can manually request contact with the healthcare provider. This request is made by pointing and clicking the computer mouse. This results in an e-mail being sent to the healthcare provider indicating that a patient wishes to obtain information or schedule an appointment. This enables the healthcare provider to contact the patient to provide information or schedule an appointment. An automated confirmation also is sent to the Internet user.

Once the referral has been made, a software application places follow-up e-mails in cue. These e-mails are staged to go out after a waiting period, at which time the Internet user and healthcare provider should have made contact. A follow-up e-mail is sent to the Internet user to confirm that he/she has made contact, to rate satisfaction, and to offer other services (such as additional contacts). A follow-up e-mail is sent to the healthcare provider to confirm that he/she has contacted the patient and to rate satisfaction.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for referring an Internet user to a healthcare provider comprising the steps of:
providing a website at which the Internet user may access healthcare information;
prompting the Internet user to provide user identifying information;
using the user identifying information provided by the Internet user to determine at least one matching healthcare provider;
displaying to the Internet user at the website a set of provider information regarding the at least one matching healthcare provider; and
generating an automated communication to the Internet user transmitting the set of provider information regarding the at least one matching healthcare provider.

2. The method according to claim 1 wherein the healthcare information accessible to the Internet user at the website comprises information regarding sleep disorders.

3. The method according to claim 1 wherein the healthcare information accessible to the Internet user at the website comprises information regarding diagnosis of medical conditions.

4. The method according to claim 1 wherein prompting the Internet user to provide user identifying information comprises prompting the Internet user to provide information regarding diagnostic criteria for a medical condition of interest.

5. The method according to claim 1 wherein prompting the Internet user to provide user identifying information comprises prompting the Internet user to provide geographical information regarding the Internet user.

6. The method according to claim 4, wherein using the user identifying information to determine at least one matching healthcare provider comprises:
determining a qualification rating of the Internet user for the medical condition of interest based on information provided by the Internet user regarding diagnostic criteria for the medical condition of interest; and
generating an automated communication to the healthcare provider transmitting the qualification rating.

7. The method according to claim 1, wherein displaying to the Internet user at the website the set of provider information comprises displaying contact information for the at least one matching healthcare provider.

8. The method according to claim 5, wherein using the user identifying information to determine at least one matching healthcare provider comprises identifying at least one matching healthcare provider located in geographic proximity to the Internet user based on the provided geographical information regarding the Internet user.

9. The method according to claim 1 further comprising providing an opportunity for the Internet user to request an appointment with the at least one matching healthcare provider.

10. The method according to claim 9, wherein providing an opportunity for the Internet user to request an appointment with the at least one matching healthcare provider comprises:
obtaining appointment request information from the Internet user; and
generating an automated communication to the healthcare provider transmitting the appointment request information obtained from the Internet user.

11. The method according to claim 1, further comprising displaying to the Internet user at the website information regarding the selection of appropriate healthcare providers.

12. The method according to claim 1, further comprising generating an automated communication to the Internet user requesting the user to provide a satisfaction rating regarding the at least one matching healthcare provider.

13. The method according to claim 1, further comprising generating an automated communication to the Internet user with information regarding additional services.
